(19) United States
(12) Patent Application Publication
(10) Pub. No.: US 2018/0112518 A1
(43) Pub. Date: Apr. 26, 2018

(54) APPLICATION OF TIEM AND DEPT DERIVATIVE OF DISTRIBUTED TEMPERATURE SURVEY (DTS) IN EVALUATING DATA QUALITY AND DATA RESOLUTION

(71) Applicant: Halliburton Energy Services, Inc., Houston, TX (US)

(72) Inventors: Hongyan Duan, Houston, TX (US); Mikko Jaaskelainen, Katy, TX (US)

(21) Appl. No.: 15/567,883

(22) PCT Filed: Jun. 15, 2015
(86) PCT No.: PCT/US2015/035819

§ 371 Date: Oct. 19, 2017

(51) Int. Cl. E21B 47/06; E21B 47/10; G01K 11/32

(52) U.S. Cl. CPC E21B 47/065; G01K 2011/324; G01K 11/32; E21B 47/1005

(57) ABSTRACT

A method for using the time derivative and depth derivative of distributed temperature sensing data to evaluate data quality and resolution of DTS data obtained from subsurface wells comprises providing a fiber optic based distributed temperature sensing measurement system through a production region; gathering the temperatures through the production region as a function of the depth in the subsurface well and as a function of the elapsed time; calculating from the gathered data the time derivative of the temperature changes as a function of depth in the subsurface well and of the elapsed time; calculating from the gathered data the depth derivative of the temperature changes as a function of depth in the subsurface well and of the elapsed time; displaying the time derivative data for analysis of the data quality of the DTS data by operators; and displaying the depth derivative data for analysis of the resolution of the DTS data by operators.

### BACKGROUND

This disclosure relates generally to temperature sensing, and more particularly, to the use of new methodologies for interpreting distributed temperature sensing information.

Fiber optic Distributed Temperature Sensing (DTS) systems were developed in the 1980s to replace thermocouple and thermistor based temperature measurement systems. DTS technology is often based on Optical Time-Domain Reflectometry (OTDR) and utilizes techniques originally derived from telecommunications cable testing. Today DTS provides a cost-effective way of obtaining hundreds, or even thousands, of highly accurate, high-resolution temperature measurements, DTS systems today find widespread acceptance in industries such as oil and gas, electrical power, and process control.

DTS technology has been applied in numerous applications in oil and gas exploration, for example hydraulic fracturing, production, and cementing among others. The collected data demonstrates the temperature profiles as a function of depth and of time during a downhole sequence. The quality of the data is critical for interpreting various fluid movements.

The underlying principle involved in DTS-based measurements is the detection of spontaneous Raman back-scattering. A DTS system launches a primary laser pulse that gives rise to two back-scattered spectral components. A Stokes component that has a lower frequency and higher wavelength content than the launched laser pulse, and an anti-Stokes component that has a higher frequency and lower wavelength than the launched laser pulse. The anti-Stokes signal is usually an order of magnitude weaker than the Stokes signal (at room temperature) and it is temperature sensitive, whereas the Stokes signal is almost entirely temperature independent. Thus, the ratio of these two signals can be used to determine the temperature of the optical fiber at a particular point. The time of flight between the launch of the primary laser pulse and the detection of the back-scattered signal may be used to calculate the spatial location of the scattering event within the fiber.

DTS technology has been applied to many different processes, like hydraulic fracture, production, cementing and others. Two methods are widely applied in industry to investigate these phenomena. DTS single trace analysis and DTS time-depth 2D image analysis. The first one is usually operated by including a limited amount of DTS curves in a Depth-Temperature plot to find those noticeable local minimum temperatures on each single trace. The second method is to the DTS data in Time-Depth 2D plot.

Of particular concern is the quality of the data gathered. DTS data can exhibit artifacts at different times during a monitoring period. That quality issue can be critical for interpreting DTS to monitor fluid activity. A second issue can be resolution (integration time) of DTS, an important parameter for data acquisition. There is a need for better tools to address these phenomena.

### BRIEF DESCRIPTION OF THE DRAWINGS

FIG. 1 illustrates a DTS plot in the time and depth scale taken during a cementing process.

FIG. 2 illustrates a depth derivative of DTS plot in depth and time scale utilizing the same data as FIG. 1.

FIG. 3 illustrates a DTS plot in the time and depth scale using data from hydraulic fracturing.

FIG. 4 illustrates a depth derivative of DTS plot in depth and time scale is using the same data as FIG. 3.

FIG. 5 is a stack of three displays of the same data illustrating first a depth derivative, then DTS integration time, then a DTS display in the depth and time scale.

FIG. 6 illustrates another stack of three displays of a different data set, again illustrating first a depth derivative, then DTS integration time, then a DTS display in the depth and time scale.

FIG. 7 illustrates the data matrices representing the DTS data for representing the depth derivative display.

FIG. 8 illustrates the data matrices representing the DTS data for representing the time derivative display.

FIG. 9 illustrates a workflow for generating the data analysis for artifact identification.

FIG. 10 illustrates a workflow for generating the data analysis for examining resolution issues.

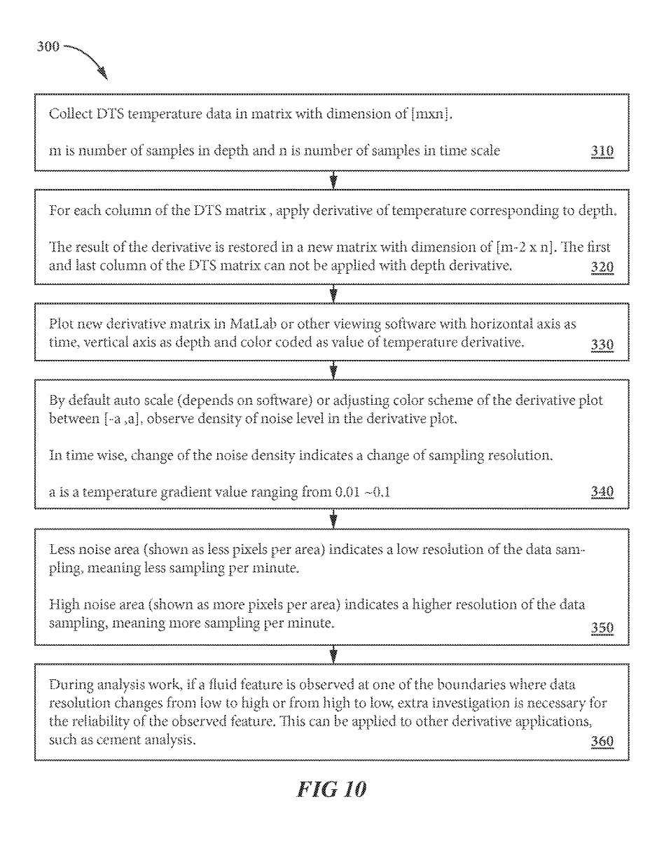

### DETAILED DESCRIPTION

In the following detailed description, reference is made to accompanying drawings that illustrate embodiments of the present disclosure. These embodiments are described in sufficient detail to enable a person of ordinary skill in the art to practice the disclosure without undue experimentation. It should be understood, however, that the embodiments and examples described herein are given by way of illustration only, and not by way of limitation. Various substitutions, modifications, additions, and rearrangements may be made without departing from the spirit of the present disclosure. Therefore, the description that follows is not to be taken in a limited sense, and the scope of the present disclosure will be defined only by the final claims.

Two methods are widely applied in industry, DTS single trace analysis and DTS time-depth 2D image analysis. The first one is usually operated by including a limited amount of DTS curves in Depth-Temperature plot to study temperature change on each single trace. The second method is to plot the DTS data in Time-Depth 2D plot, often presented on monitors for examination.

DTS technology has been applied to many different processes, such hydraulic fracture, production, and cementing. But both the quality (minimum artifacts) of the data and the resolution of the data are important. The quality is critical for interpreting the DTS data, particularly for measuring fluid activities. And the resolution (integration time) of the DTS data is one of the key parameters for data acquisition. We will show that the use of time and depth derivative of DTS data can be a useful tool for evaluating the quality and resolution of subsurface DTS data. The use of the derivative of DTS data, either the depth derivative or the time derivative can give a very fast and direct way to observe the quality of the DTS data and the resolution changes of the data.

As an example the depth or time derivative of DTS data is a tool that can let us easily identify the geometry and duration of artifacts in the data. It also lets us see how the data resolution changes with time directly from the plot. These will be shown in the following examples.

Quality (Artifacts)

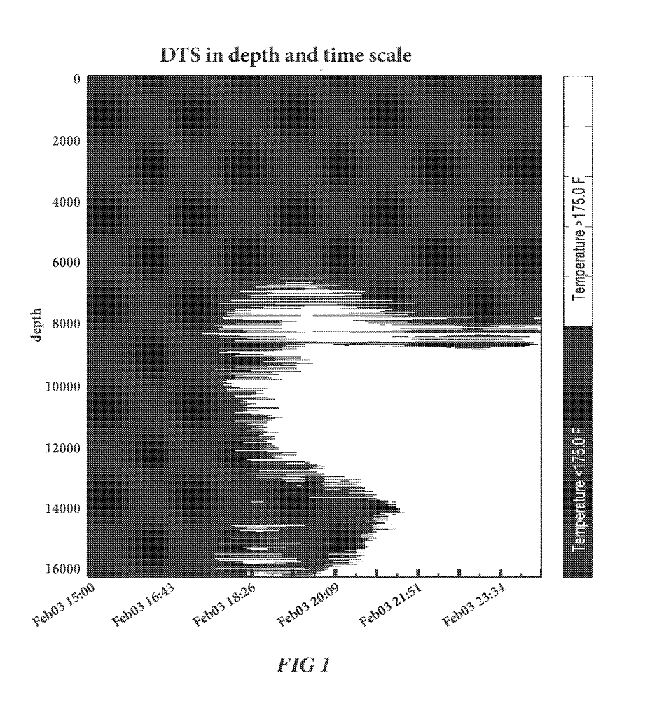

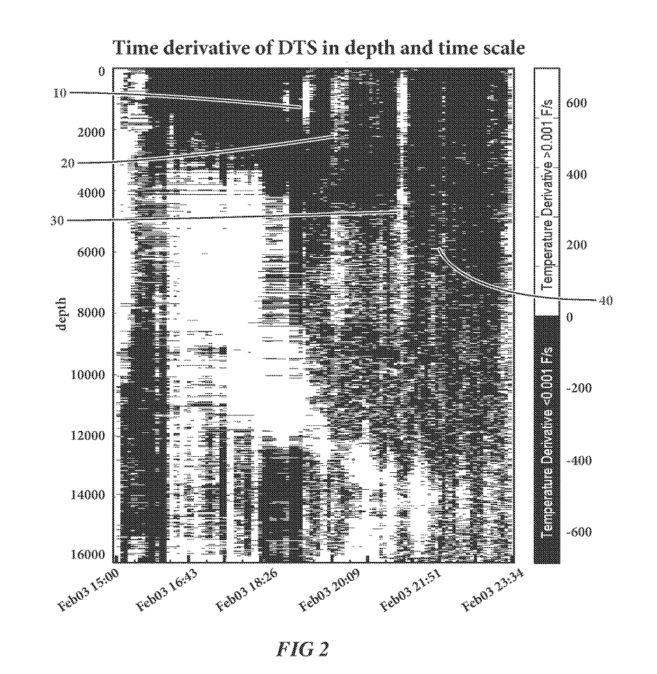

The first two examples shown represent the discovery of artifacts in the data from the use of temperature derivatives of the DTS data. The first example is shown in FIGS. 1 and 2. The data set is collected during a cementing process. FIG. 1 is a DTS data set in time-depth 2D. FIG. 2 is the time derivative of the same DTS data, also in a time-depth plot. In FIG. 2 the vertical lines at 10, 20, 30, and 40, are artifact stripes found every other hour in varied widths. Their artifact features can be characterized by a consistency along all the depths from surface to the bottom. The data instability of this job was caused by a light loss, which causes attenuation at all depths. This information is simply not available in a conventional DTS depth-time presentation.

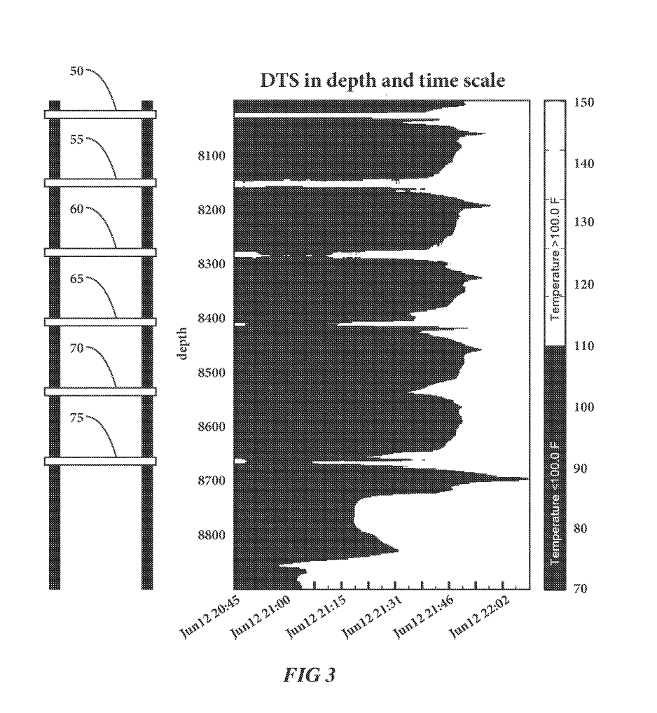

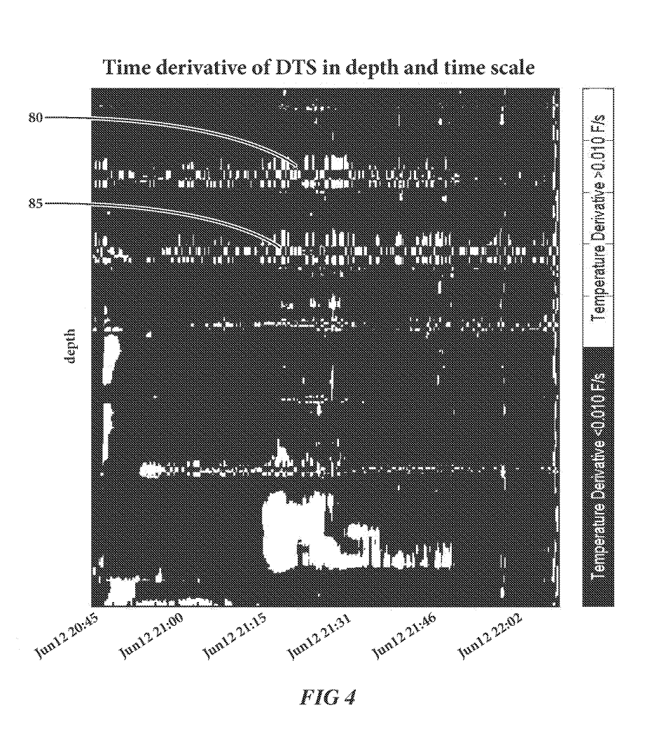

The second example (FIGS. 3 and 4) (example 80, 85) uses data from hydraulic fracturing. The high pressure conditions required for hydraulic fracturing usually require the use of swellable packers 50, 55, 60, 65, 70, 75 to provide reliable isolation, sufficient strength, and durability during the stages of fracturing. FIGS. 3 and 4 show the same data set of a fracturing operation, with FIG. 3 being a more conventional display of DTS data in time-depth 2D, and FIG. 4 being that same data with the time derivative of the DTS data being shown in a time-depth plot. The artifacts (examples 80, 85) in this case are amount of small pixels of high derivative value line up in turns through all time at the depths of the swellable packers. This might be caused by external force applied by swellable packers on fiber and cause distortion of the light path.

Resolution

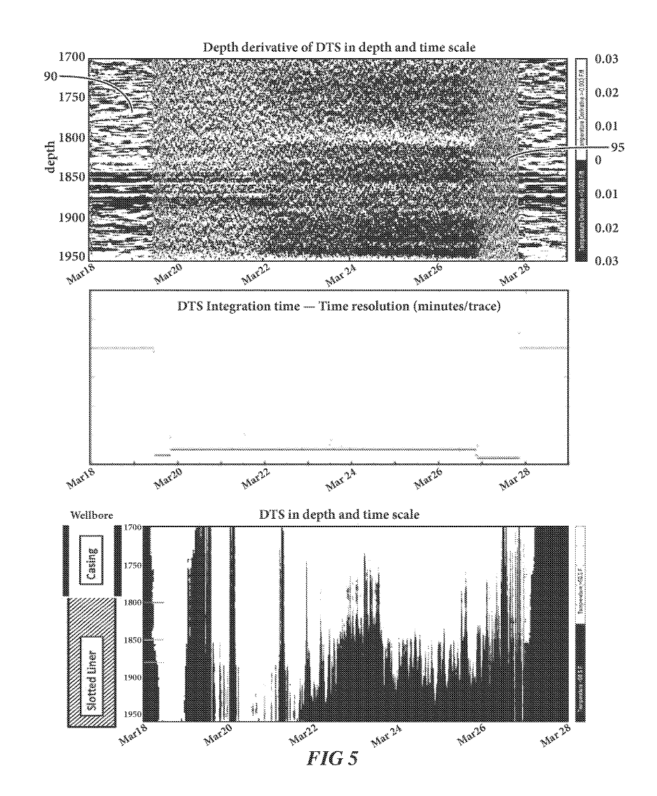

The next two FIGS. (5 & 6) illustrates the detection of resolution issues using depth derivatives. FIG. 5 (three stacked presentations) presents first a depth derivative of the DTS data from a set of data, the actual recorded interrogation time is plotted in the middle graph to compare to the observations made from a derivative plot. The original DTS data is shown in the bottom of the three presentations. In the (top) derivative plot clear differences in resolution can be shown evidenced by low resolution 90 during one time period and much higher resolution 95 shown in a later period. This discovery is not evident in the conventional DTS presentation in the bottom of the three presentations of FIG. 5.

A similar conclusion can be presented in 6. In this case a DTS data set from gas production is presented. The bottom of the three presentations shows that formation gas is produced from two perforation depths, (100, 110). There is however no information can be drawn that a change of data resolution occurred. In the top presentation the same data is used but presented as the depth derivative. In this case two distinct periods of high resolution 120 and low resolution 130 are evident, and is consistent with the original interrogation chart (middle plot).

Generation of Derivative DTS Data

The disclosure herein anticipates any mathematically correct manner of generating the derivative data. The example embodiment for calculating the depth derivative is explained as follows.

Derivative data from DTS data can be generated by feeding the numerical data of temperature as a function of depth and time into a matrix and then computationally moving through all of the matrix data points to calculate derivative values for each matrix element. This can be done as either depth derivatives or as time derivatives. These derivative values can then be presented as a matrix of numbers, or, more usefully can be presented as color images in which the various colors represent different values of the derivatives. As discussed earlier, they are presented herein as black and white scale images because color presentation cannot be used in patents but even black white presentations clearly show important features that are not evident in the presentation of the conventional DTS data alone.

Depth Derivative of DTS:

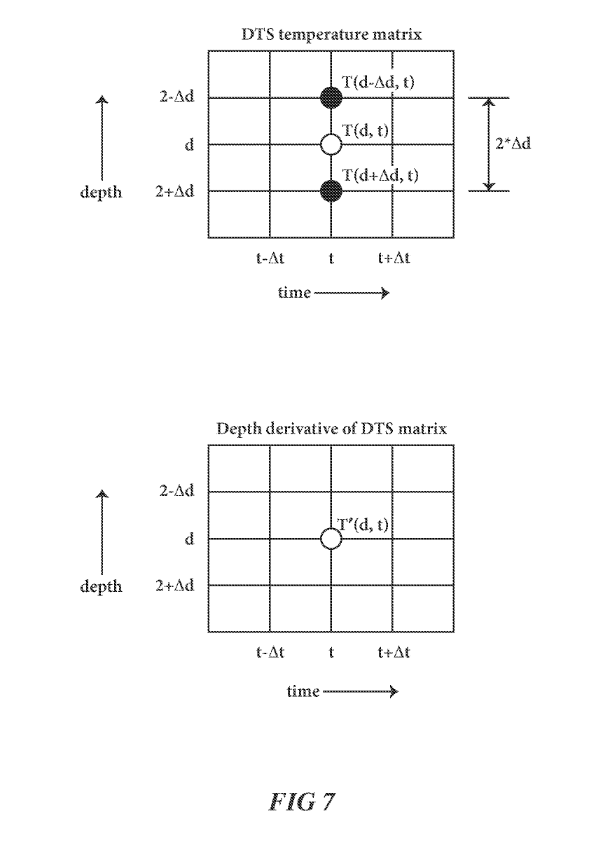

The presentation of the method of generating a depth derivative data set is illustrated in FIG. 7. In this example the computation language MatLab is used to compute regular DTS data into depth derivative of DTS. And the result can then be plotted by MatLab in depth-time scale.

For DTS measurement, Temperature is function of depth and time:

T=T(depth, time²⁰) (1)

Data is loaded into Matab and stored as a DTS temperature matrix. See the first matrix in FIG. 7.

The depth derivative of DTS, also called the DTS depth gradient, is then computed as:

T̂′(d,t)=(T(d+Δd,t)−T(d+Δd,t))/(2*Δd) (2)

The depth derivative at any depth and time step is calculated by subtracting the temperature at its previous depth from the one at its next depth and the result is divided by the distance between these two depths.

This results in a depth derivative of the DTS temperature matrix, shown as the second matrix in FIG. 7 wherein each point is a derivative data point to be displayed.

Both the DTS temperature matrix and DTS derivative matrix can be plotted as a depth-time 2D color map by MatLab function pcolor(d,t,T) or pcolor(d,t,T′). Input parameters d and t are depth and time vectors. Input T is a 2D matrix with number of rows as d and number of columns as t.

By default, MatLab uses a Blue-Red color scheme represent the value of the temperature or value of the derivative. In the DTS plot if shown in color, blue represents a low temperature while red represents a high temperature. Again, as explained before, because color cannot be used in patent applications these are presented as black/white scale images which still show the new possibilities of data presentation possible by the use of displayed color data.

In DTS the depth derivative (DTS depth gradient), black (blue in color scale) represents a temperature decrease along the depth. White (red in color scale) represents a temperature increase along the depth. Large value in white zone indicates a large temperature increase per unit length. Large negative value in black zone indicates a large temperature drop per unit length. Again because color cannot be used in patent applications these are presented as black/white scale images which still show the new possibilities of data presentation possible by the use of displayed color data.

The resulting depth derivative temperature data as a function of depth and time can be presented in a number of ways. In one example the actual numerical values can be stored for later retrieval and then either displayed on a monitor or printed for study. In another example the resulting depth derivative of temperature can be displayed as different colors on a color display for better understanding and interpretation. In yet another example that same data can be displayed in gray scale.

Time Derivative of DTS:

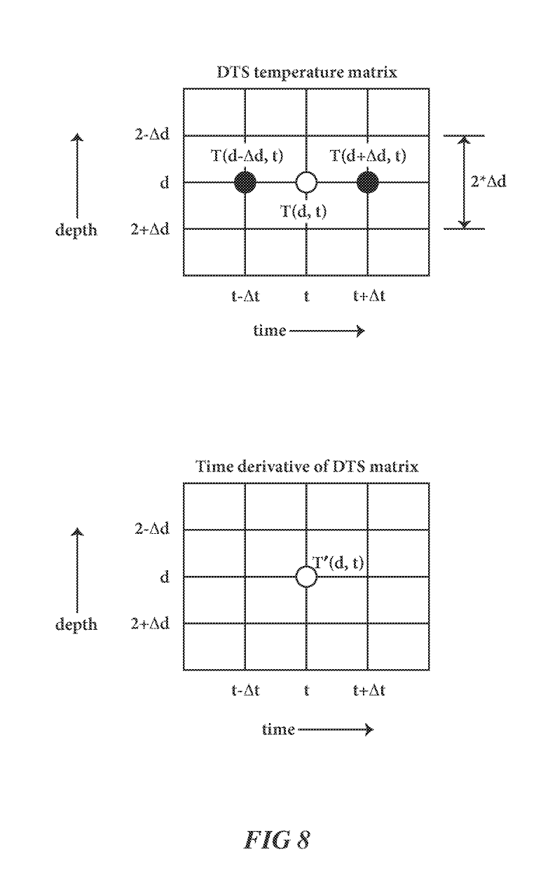

The presentation of the method of generating a time derivative data set is illustrated in FIG. 8. In this example the computation language MatLab is used to compute regular DTS data into a time derivative of DTS. And the result is also plotted by MatLab in a depth-time scale.

For the DTS measurement, Temperature is function of depth and time:

T=T(depth, time) (3)

Data is loaded into MatLab and stored as a matrix. See the first matrix of FIG. 8.

The time derivative of DTS, also called DTS time gradient, is computed as:

T̂′(d,t)=(T(d,t+Δd,t)−T(d,t+Δd,t))/(2*Δdt²⁰) (4)

The time derivative at any depth and time step is calculated by subtracting the temperature at its previous time step from the one at its next time step and result is divided by the time interval between these two steps.

The structure of the derivative matrix is shown as the second matrix in FIG. 8:

Both DTS and DTS derivative matrix can be plotted as a depth-time 2D color map by MatLab function pcolor(d,t,T) or pcolor(d,t,T′). Input parameters d and t are depth and time vectors. Input T or T′ is a 2D matrix with number of rows as d and number of columns as t.

By default, MatLab uses a Blue-Red color scheme represent the value of the temperature or value of the derivative. In the DTS plot, black (blue in color scale) represents a low temperature while white (red in color scale) represents a high temperature. In DTS time derivative (DTS time gradient) plot, black (blue in color scale) represents a temperature decrease along the time. white (red in color scale) represents a temperature increase along the time. A large value in red (darker) zone indicates a large temperature increase per second. Large negative value in blue zone indicates a large temperature drop per second. Again because color cannot be used in patent applications these are presented as black/white images which still show the new possibilities of data presentation possible by the use of displayed color data.

Quality Analysis Workflow

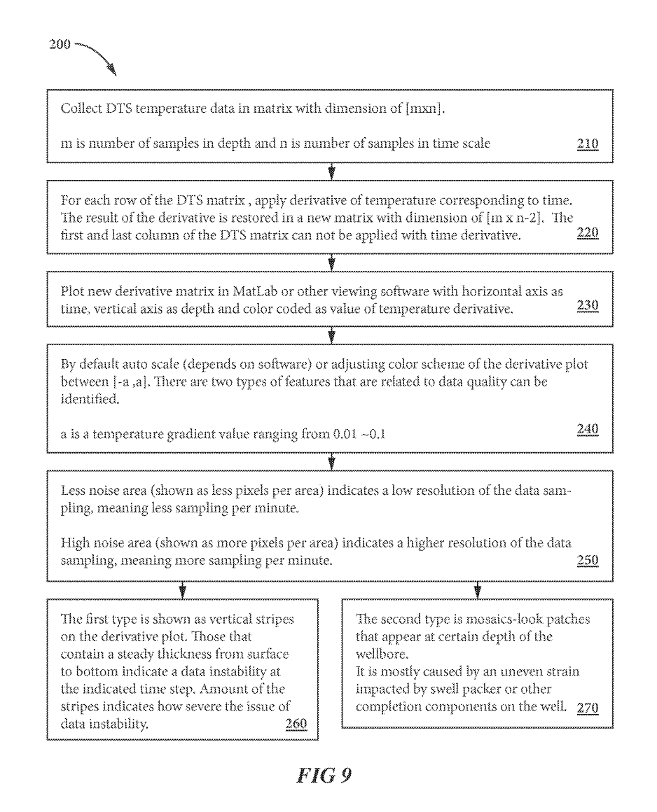

The quality analysis method can be described alternately with the process 200 as in FIG. 9. In the first step 210 a DTS system is used to collect temperature data from application into a matrix of dimensions [m×n], where m is the number of samples taken in the depth scale and n is the number of samples taken in time scale. In the step 220 for each row of the DTS matrix, the derivative of temperature corresponding to time is calculated. The result of this derivative is stored in a new matrix with dimension [m×n−2]. The first and last column of the DTS matrix cannot be applied with the time derivative. The developing temperature derivative matrix is shown in FIG. 8. In the step 230 any viewing software such as MatLab can be used to plot the derivative matrix with time as the horizontal axis and depth as the vertical axis. If color display is operable the color can be coded as a value of temperature derivative. The user can then adjust (step 240) the color scheme of the derivative plot until one or more features related to data quality are evident. As shown in step 250 less noise area indicates a low resolution of the data sampling and high noise area indicates a higher resolution of the data sampling. Two types of artifacts can appear. In step 260 vertical stripes containing a visible thickness from surface to bottom can indicate a data instability at the indicated time step. Alternately (step 270) mosaic-look patches that appear at certain depths of the wellbore can indicate artifacts due to completion components of the well.

Resolution Analysis Workflow

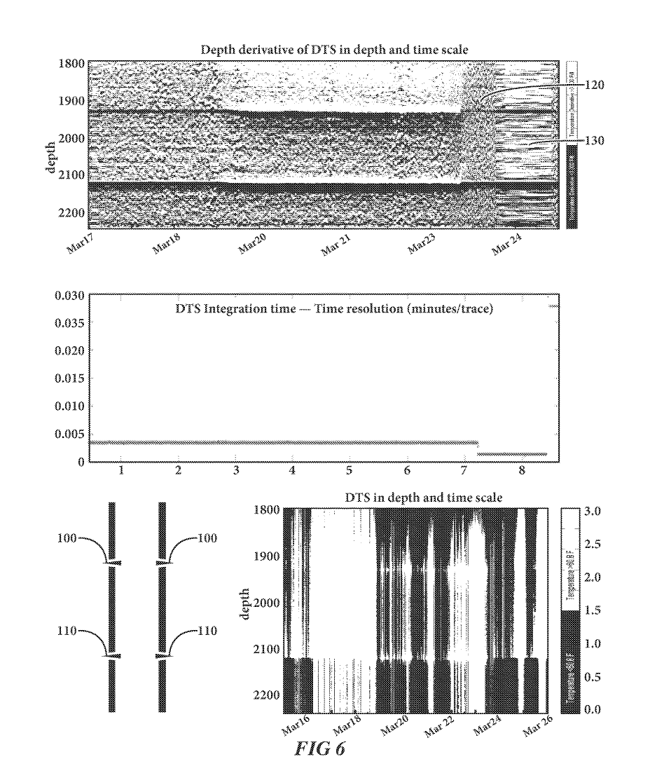

The resolution analysis can be described alternately with the process 300 as in FIG. 9. In the first step 310 a DTS system is used to collect temperature data from a production well into a matrix of dimensions [m×n], where m is the number of samples taken in the depth scale and n is the number of samples taken in time scale. In the step 320 for each column of the DTS matrix, the derivative of temperature corresponding to depth is calculated. The result of this derivative is stored in a new matrix with dimension [m−2×n]. The first and last column of the DTS matrix cannot be applied with the depth derivative. The developing depth derivative matrix is shown in FIG. 7. In the step 330 any viewing software such as MatLab can be used to plot the derivative matrix with time as the horizontal axis and depth as the vertical axis. If color display is operable the color can be coded as a value of temperature derivative. The user can then adjust (step 340) the color scheme of the derivative plot and observe the density of noise level in the derivative plot (see FIG. 5 or 6). Less noise area (shown as less pixels per area) indicates a low resolution of the data sampling, meaning less sampling per minute. High noise are (shown as more pixels per area) indicates a higher resolution of the data sampling, meaning more sampling per minute (step 350). During the analysis work, (step 360) if a fluid feature is observed at one of the boundaries where data resolution changes from low to high, or high to low, extra investigation may be needed to verify the reliability of the observed fluid feature.

The resulting depth derivative temperature data as a function of depth and time can be presented in a number of ways. In one example the actual numerical values can be stored for later retrieval and then either displayed on a monitor or printed for study. In another example the resulting time derivative of temperature can be displayed as different colors on a color display for better understanding and interpretation. In yet another example that same data can be displayed in gray scale.

This methodology can be applied in real time data monitoring, offering more insight than conventional DTS. Artifact fluctuation in DTS data either occurs too short to be noticed or is misinterpreted as a fluid activity. But with depth or time derivative of DTS data the geometry and duration of data artifacts can be detected and the change of data resolution can be identified at different times

Although certain embodiments and their advantages have been described herein in detail, it should be understood that various changes, substitutions and alterations could be made without departing from the coverage as defined by the appended claims. Moreover, the potential applications of the disclosed techniques is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized. Accordingly, the appended claims are intended to include within their scope such processes, machines, manufactures, means, methods or steps.

1. A method for using the time derivative and depth derivative of distributed temperature sensing data to evaluate data quality and resolution of DTS data obtained from subsurface wells comprising:
a. providing a fiber optic based distributed temperature sensing measurement system through a production region;
b. gathering the temperatures through the production region as a function of the depth in the subsurface well and as a function of the elapsed time;
c. calculating from the gathered data the time derivative of the temperature changes as a function of depth in the subsurface well and of the elapsed time;
d. calculating from the gathered data the depth derivative of the temperature changes as a function of depth in the subsurface well and of the elapsed time;
e. displaying the time derivative data for analysis of the data quality of the DTS data by operators.
f. displaying the depth derivative data for analysis of the resolution of the DTS data by operators.

2. The method for using the time derivative and depth derivative of distributed temperature sensing data to evaluate data quality and resolution of DTS data obtained from subsurface wells of claim 1 wherein the numerical values of the derivative data are recorded and printed or displayed.

3. The method for using the time derivative and depth derivative of distributed temperature sensing data to evaluate data quality and resolution of DTS data obtained from subsurface wells of claim 1 wherein the derivative data is displayed in colors as a function of depth and time on a display monitor.

4. The method for using the time derivative and depth derivative of distributed temperature sensing data to evaluate data quality and resolution of DTS data obtained from subsurface wells of claim 1 wherein the derivative data is displayed in black/white scale as a function of depth and time on a display monitor.

5. The method for using the time derivative and depth derivative of distributed temperature sensing data to evaluate data quality and resolution of DTS data obtained from subsurface wells of claim 1 wherein the derivative data is displayed in grey scale as a function of depth and time on a display monitor.

6. A method for using the time derivative of distributed temperature sensing data to evaluate data quality of DTS data obtained from a subsurface well comprising:
a. providing a fiber optic based distributed temperature sensing measurement system through a production region;
b. gathering the temperatures through the production region as a function of the depth in the subsurface well and as a function of the elapsed time;
c. assembling the data into a DTS matrix of [m×n] wherein m is the number of samples collected in the depth scale and n is the number of samples collected in the time scale;
d. for each row of the DTS matrix calculating a derivative of the temperature as a function of time and storing it in a new matrix with dimensions [m×n−2];
e. displaying the derivative matrix with one axis as time and another axis as depth and color coding the value of the temperature derivative;
f. adjusting the color scheme until one or more features related to data quality are evident;
g. displaying the time derivative data for analysis of the data quality of the DTS data obtained from the subsurface well.

7. The method for using the time derivative of distributed temperature sensing data to evaluate data quality of DTS data obtained from a subsurface well of claim 6 wherein the one or more features are vertical stripes on the derivative plot.

8. The method for using the time derivative of distributed temperature sensing data to evaluate data quality of DTS data obtained from a subsurface well of claim 6 wherein the one or more features are mosaic like patches appearing at different depths of the subsurface well.

9. The method for using the time derivative of distributed temperature sensing data to evaluate data of DTS data obtained from a subsurface well of claim 6 wherein the time derivative data is displayed in colors as a function of depth and time on a display monitor.

10. The method for using the time derivative of distributed temperature sensing data to evaluate data quality of DTS data obtained from a subsurface well of claim 6 wherein the time derivative data is displayed in black/white scale as a function of depth and time on a display monitor.

11. The method for using the time derivative of distributed temperature sensing data to evaluate data quality and resolution of DTS data obtained from a subsurface well of claim 6 wherein the time derivative data is displayed in gray scale as a function of depth and time on a display monitor.

12. The method for using the time derivative of distributed temperature sensing data to evaluate data quality of DTS data obtained from a subsurface well of claim 6 wherein the numerical values of the time derivative data are recorded and printed or displayed.

13. A method for using the depth derivative of distributed temperature sensing data to evaluate the resolution of DTS data obtained from a subsurface well comprising:
a. providing a fiber optic based distributed temperature sensing measurement system through a production region;
b. gathering the temperatures through the production region as a function of the depth in the subsurface well and as a function of the elapsed time;
c. assembling the data into a DTS matrix of [m×n] wherein m is the number of samples collected in the depth scale and n is the number of samples collected in the time scale;
d. for each column of the DTS matrix calculating a derivative of the temperature as a function of depth and storing it in a new matrix with dimensions [m−2×n];
e. displaying the derivative matrix with one axis as time and another axis as depth and color coding the value of the temperature derivative;
f. adjusting the color scheme to reveal any variable densities of the noise level during different time intervals;
g. displaying the depth derivative data for analysis of the resolution of the DTS data obtained from the subsurface well.

14. The method for using the depth derivative of distributed temperature sensing data to evaluate the resolution of the DTS data obtained from a subsurface well of claim 13 wherein the depth derivative data is displayed in colors as a function of depth and time on a display monitor.

15. The method for using the depth derivative of distributed temperature sensing data to evaluate the resolution of the DTS data obtained from a subsurface well of claim 13 wherein the depth derivative data is displayed in black/white scale as a function of depth and time on a display monitor.

16. The method for using the depth derivative of distributed temperature sensing data to evaluate the resolution of the DTS data obtained from a subsurface well of claim 13 wherein the depth derivative data is displayed in gray scale as a function of depth and time on a display monitor.

17. The method for using the depth derivative of distributed temperature sensing data to evaluate the resolution of the DTS data obtained from a subsurface well of claim 13 wherein the numerical values of the depth derivative data are recorded and printed or displayed.
